(19) United States
(12) Patent Application Publication
(10) Pub. No.: US 2013/0182188 A1
(43) Pub. Date: Jul. 18, 2013

(54) METHOD FOR CONTROLLING DIGITAL VIDEO DEVICE

(71) Applicant: NOVATEK MICROELECTRONICS CORP., Hsinchu (TW)

(72) Inventors: Xiang-Jun Li, Shenzhen (CN); Lei Li, Shanghai (CN)

(73) Assignee: NOVATEK MICROELECTRONICS CORP., Hsinchu (TW)

(21) Appl. No.: 13/656,756

(22) Filed: Oct. 22, 2012

(30) Foreign Application Priority Data
Jan. 13, 2012 (CN) 201210064849.6

(51) Int. Cl. H04N 5/455

(52) U.S. Cl. 348/726; 348/E05.113

(57) ABSTRACT

A method for controlling a digital video device is provided. The method includes receiving multi-channel transport streams by a tuner of the digital video device. The method further includes obtaining a process identifier (PID) corresponded to a specific frequency and setting the tuner and a demodulator of the digital video device to the specific frequency. The method further includes turning on a demultiplexer of the digital video device to obtained program specific information/service information (PSI/SI) of the multi-channel transport streams and controlling a decoder of the digital video device to decode the PSI/SI according to the PID during locking the tuner and the demodulator to the specific frequency. Accordingly, the time for switching program could be reduced, and the speed for switching program could be improved.

### CROSS-REFERENCE TO RELATED APPLICATION

This application claims the priority benefit of China application serial no. 201210064849.6, filed on Jan. 13, 2012. The entirety of the above-mentioned patent application is hereby incorporated by reference herein and made a part of this specification.

### TECHNICAL FIELD

The invention generally relates to a method for controlling a digital video device, and more particularly to a method for controlling a digital video device which can improve the speed for switching program.

### BACKGROUND

With the rapid growth of multimedia technology, a variety of video services have been provided, such as terrestrial broadcasting, satellite broadcasting, cable broadcasting and internet television, these services allow the user to enjoy high quality video service no matter at home or out of home. Therefore, as long as purchasing the video products, such as televisions, set-top boxes, and so on, which are capable of receiving the signals of the services described above, the user can watch many interesting programs immediately.

However, the user will watch the program which himself/herself has interest in, so it is necessary for the user to switch program. Referring to FIG. 1, FIG. 1 is a functional block diagram illustrating a general digital video device. A digital video device 100 has a tuner 110, a demodulator 120, a demultiplexer 130 and a decoder 140. The tuner 110 is configured to receive a radio-frequency (RF) signal SRF of multi-channel transport streams, amplify the received RF signal SRF. The tuner 110 may be locked to a specific frequency to output a signal SF. It should be noted that the specific frequency is a frequency corresponding to the program which the user wants to watch. The tuner 110 filters the signals of the multi-channel transport streams, which are not corresponded to the specific frequency. The demodulator 120 is configured to demodulate the signal SF outputted from the tuner 110 to a baseband signal so as to output a transport stream TS with the specific frequency.

The demultiplexer 130 is configured to demultiplex the transport stream TS to obtain a program specific information/service information (PSI/SI) and a process identifier (PID). The PSI/SI is a basic signal of digital video broadcasting (DVB), which is used to describe the information about network, transport streams, program events, services and so on. The criterion which the PSI/SI follows is formulated in standard ISO/IEC 13818-1. Besides, the PID is used to distinguish different programs in the transport stream. The PIDs of the programs are different from each other.

The decoder 140 is configured to decode the PSI/SI to output an image signal IMG. The image signal IMG can be transmitted to a display to display corresponding frames.

Referring to FIG. 1 and FIG. 2, FIG. 2 illustrates a flowchart of a method for controlling the digital video device 100 according to prior art. According to the method of prior art for controlling the digital video device 100, when the user controls the digital video device 100 to switch program, the digital video device 100 may first set the frequency of the tuner 110 and the demodulator 120 to adjust the frequency of the tuner 110 and the demodulator 120 from a frequency to another frequency (step S210). For illustration purpose, the following locked frequency of the tuner 110 and the demodulator 120 described below is defined as a “specific frequency” Afterward, the digital video device 100 determines whether the tuner 110 and the demodulator 120 have been locked to the specific frequency (step S220). If the tuner 110 and the demodulator 120 are not locked to the specific frequency yet, executing step S220 until the tuner 110 and the demodulator 120 are locked to the specific frequency. Then the digital video device 100 may turn on the demultiplexer 130 to begin demultiplexing the transport stream TS to obtain the PSI/SI. And then, the digital video device 100 may set the decoder 140 to control the decoder 140 to begin decoding the PSI/SI to output the image signal IMG (step S240).

The abovementioned steps S230 and S240 should be executed after steps S210 and S220 are executed. Therefore, according to the control method of prior art, the demultiplexer 130 and the decoder 140 may proceed a demultiplexing process and a decoding process respectively after locking the tuner 110 and the demodulator 120 to the specific frequency. Accordingly, the time spent by the digital video device 100 for switching program is too long for some users which seek high efficiency, such that it can't satisfy the users' requirements.

### SUMMARY

A method for controlling a digital video device is provided, which is capable of reducing the time for switching program, and improving the speed for switching program.

A method for controlling a digital video device is provided. The method includes receiving multi-channel transport streams through a tuner of the digital video device. The method further includes obtaining a process identifier (PID) corresponded to a specific frequency and setting the tuner and a demodulator of the digital video device to the specific frequency. The method further includes turning on a demultiplexer of the digital video device to obtained program specific information/service information (PSI/SI) of the multi-channel transport streams and controlling a decoder of the digital video device to decode the PSI/SI according to the PID during locking the tuner and the demodulator to the specific frequency.

According to an embodiment of the invention, the tuner is configured to the filter signals which are not corresponded to the specific frequency of the multi-channel transport streams, and the demodulator is configured to modulate an output signal of the tuner to a baseband signal to output the transport stream with the specific frequency.

According to an embodiment of the invention, the demultiplexer outputs the PSI/SI of the specific frequency and the decoder decodes the PSI/SI of the specific frequency after locking the tuner and the demodulator to the specific frequency.

According to an embodiment of the invention, the decoder outputs a black screen signal when the tuner and the demodulator are not locked to the specific frequency.

According to an embodiment of the invention, the decoder stops outputting the black screen signal after locking the tuner and the demodulator to the specific frequency, and outputs an image signal according to a result of decoding the PSI/SI.

According to an embodiment of the invention, the digital video device is a set-top box.

According to an embodiment of the invention, the digital video device is a digital television.

In summary, the invention provides a method for controlling the digital video device. During locking the tuner and the demodulator to the specific frequency, the digital video device turns the demultiplexer thereof and controls the decoder thereof to decode the PSI/SI according to the PID. Accordingly, when the digital video device are switching program, since the process of locking the frequency and the process of demultiplexing and decoding are performed simultaneously, the time for switching program could be reduced, and the speed for switching program could be improved.

In order to make the aforementioned and other features and advantages of the invention more comprehensible, embodiments accompanying figures are described in detail below.

### BRIEF DESCRIPTION OF THE DRAWINGS

FIG. 1 is a functional block diagram illustrating a general digital video device.

FIG. 2 is a flowchart of a method according to prior art for controlling the digital video device in FIG. 1.

FIG. 3 is a flowchart of a method for controlling the digital video device in FIG. 1 according to an embodiment of the invention.

FIG. 4 is a flowchart of a method for controlling digital video device in FIG. 1 according to an embodiment of the invention.

### DESCRIPTION OF THE EXEMPLARY EMBODIMENTS

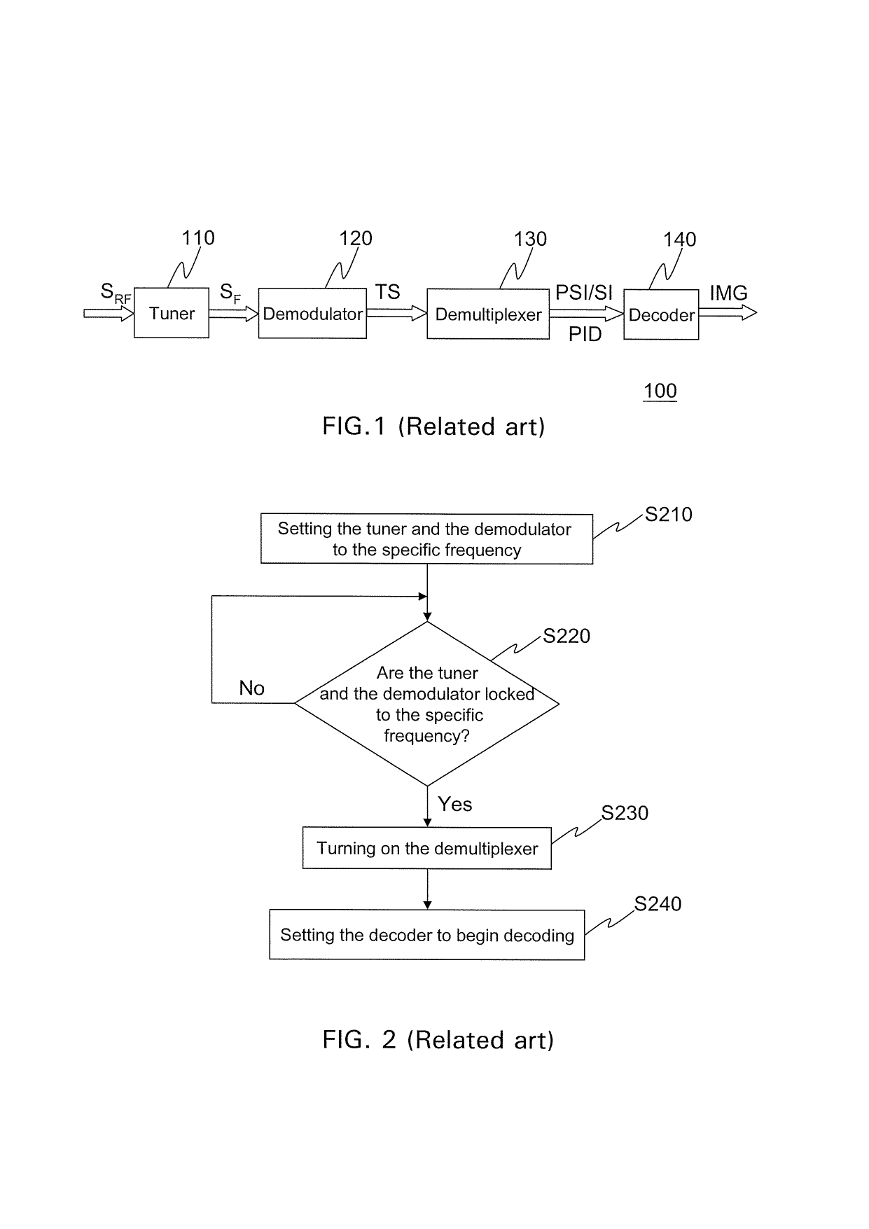

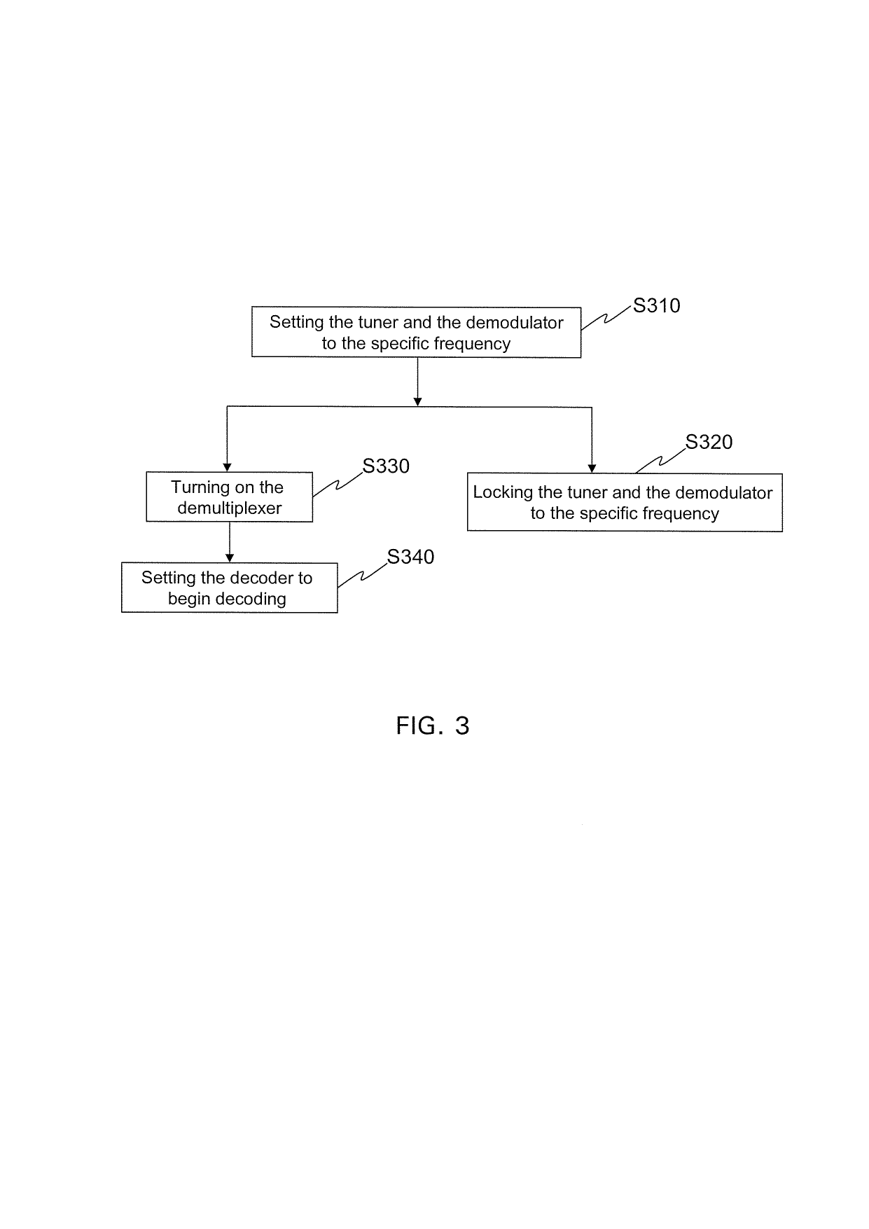

Referring to FIG. 1 and FIG. 3. FIG. 3 illustrates a flowchart of a method for controlling the digital video device 100 according to an embodiment of the invention. The main difference of the method of the invention and the method of prior art is: according to the invention, during locking a tuner 110 and a demodulator 120 to the specific frequency, the demultiplexer 130 could be turned on to obtain program specific information/service information (PSI/SI) and the decoder 140 could be controlled to decode PSI/SI. In other words, the demultiplexer 130 and the decoder 140 can operate before locking the tuner 110 and the demodulator 120 to the specific frequency. Accordingly, the time for the digital video device 100 to switch program could be reduced, and the speed for the digital video device 100 to switch program could be improved.

According to the method of the present embodiment, when a user controls the digital video device 100 to switch program, the digital video device 100 sets the frequency of the tuner 110 and the demodulator 120 to make the frequency of tuner 110 and demodulator 120 be switched to the specific frequency (step S310). Herein the “specific frequency” is defined as that described above, i.e., the frequency which the tuner 110 and the demodulator 120 may be locked to. Then, the digital video device 100 may execute step S320 and S330 in the meantime. In step S320, the digital video device 100 locks the tuner 110 and the demodulator 120 to the specific frequency. In step S330, the digital video device 100 turns on the demultiplexer 130 to obtain PSI/SI. After executing step S330, the digital video device 100 executes step S340 to control the decoder 140 to begin decoding the PSI/SI according to the PID, which is corresponded to the specific frequency, so as to output an image signal IMG. Since steps S330 and S340 are executed in parallel with step S320, in comparison to the method of prior art which executes steps S210, S220, S230 and S340 sequentially, the method according to the present embodiment could reduce the time for switching program, and could improve the speed for switching program.

According to an embodiment of the invention, before controlling the digital video device 100 to switch program, the digital video device 100 can obtain the related information of the specific frequency, wherein the related information includes the PID corresponded to the specific frequency. Therefore, when executing steps S330 and S340, the digital video device 100 can set the demultiplexer 130 and the decoder 140 directly regardless of whether the tuner 110 and the demodulator 120 are locked to the specific frequency. Furthermore, the digital video device 100 may perform a process to search channel before outputting the image signal IMG, wherein the process of searching channel is a step of searching the frequencies on a program list one by one according to a local standard channel list. The digital video device 100 parses a program info nation list from the RF signal SRF, and stores the program list in a database. When switching program, digital video device 100 extracts the information (e.g., frequency—PID, etc.) of the program be switched to from the program list of the database, and uses the information to switch program.

In addition, when the tuner 110 and the demodulator 120 are not locked to the specific frequency while the digital video device 100 has finished executing steps S330 and S340, the image signal IMG may be a black screen signal, and a related audio signal may be a mute signal if the related audio signal exists. After locking the tuner 110 and the demodulator 120 to the specific frequency, the decoder 140 stops outputting the black screen signal immediately, and outputs the image signal IMG according to the result of decoding the PSI/SI.

In an embodiment of the invention, the digital video device described above can be a set-top box. In an embodiment of the invention, the digital video device described above can be a digital television.

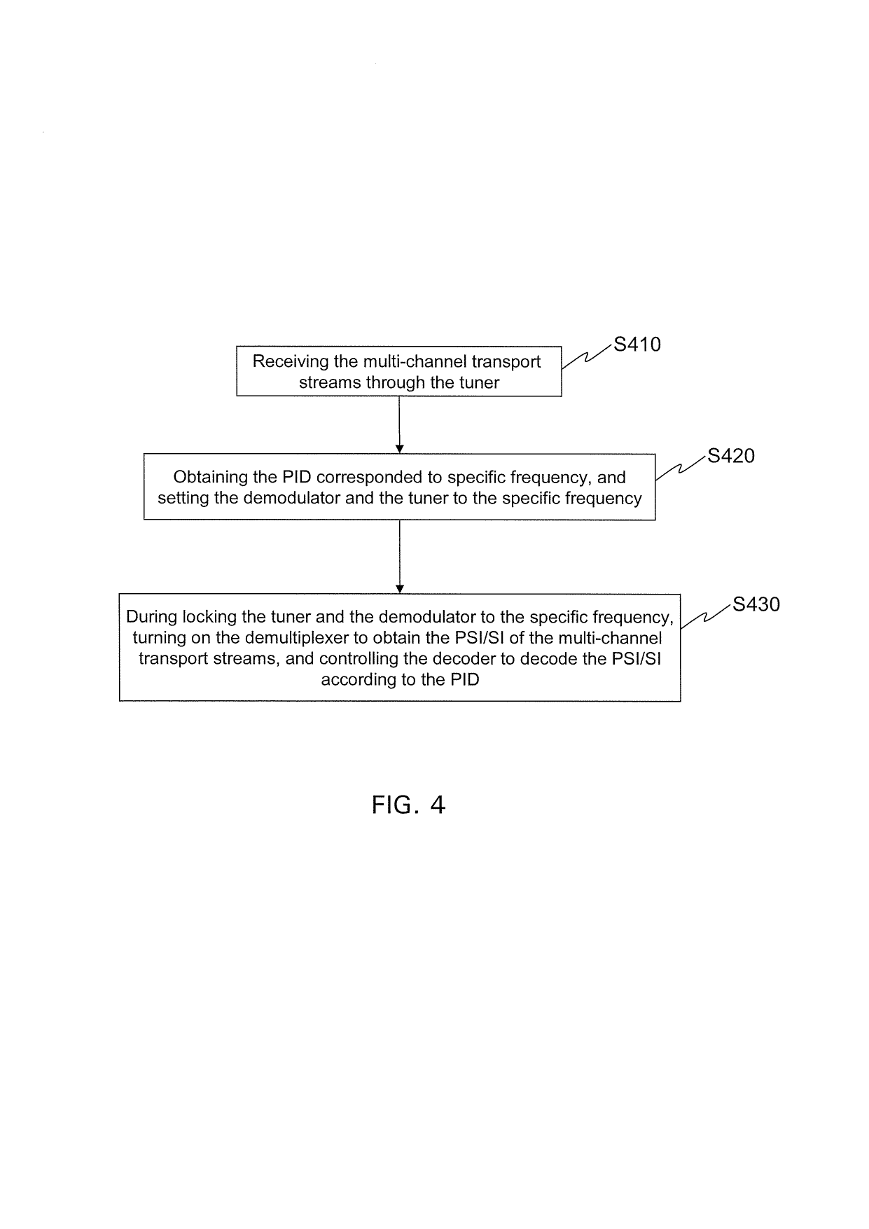

Referring to FIG. 1 and FIG. 4. FIG. 4 illustrates a flowchart of a method for controlling the digital video device 100 in FIG. 1 according to an embodiment of the invention. In step S410, the tuner 110 of the digital video device 100 receives the RF signal SRF of the multi-channel transport streams. In step S420, the digital video device 100 obtains the PID corresponded to the specific frequency, and sets the tuner 110 and the demodulator 120 of the digital video device 100 to the specific frequency. In step S430, during locking the tuner 110 and the demodulator 120 to the specific frequency, the digital video device 100 turns on the demultiplexer 130 to obtain the PSI/SI of the multi-channel transport streams and controls the decoder 140 to decode the PSI/SI according to the PID.

In summary, the invention provides a method for controlling the digital video device which is capable of turning on the demultiplexer of the digital video device and decoding the PSI/SI according to the PID simultaneously during locking the tuner and the demodulator to the specific frequency. Therefore, because the process of locking the frequency and the process of demultiplexing and decoding are performed simultaneously when the digital video device are switching program, the time for switching program could be reduced, and the speed for switching program could be improved.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A method for controlling a digital video device, comprising:
receiving a radio frequency (RF) signal of multi-channel transport streams through a tuner of the digital video device;
obtaining a process identifier (PID) corresponded to a specific frequency, and setting the tuner and a demodulator of the digital video device to the specific frequency; and
turning on a demultiplexer of the digital video device to obtain program specific information/service information (PSI/SI) of the multi-channel transport streams and controlling a decoder of the digital video device to decode the PSI/SI according to the PID during locking the tuner and the demodulator to the specific frequency.

2. The method as claimed in claim 1, wherein the tuner is configured to filter signals, which are not corresponded to the specific frequency, of the multi-channel transport streams, and the demodulator is configured to modulate an output signal of the tuner to a baseband signal to output a transport stream with the specific frequency.

3. The method as claimed in claim 1, wherein the demultiplexer outputs the PSI/SI of the specific frequency and the decoder decodes the PSI/SI of the specific frequency after locking the tuner and the demodulator to the specific frequency.

4. The method as claimed in claim 1, wherein the decoder outputs a black screen signal when the tuner and the demodulator are not locked to the specific frequency.

5. The method as claimed in claim 4, wherein the decoder stops outputting the black screen signal after locking the tuner and the demodulator to the specific frequency, and outputs an image signal according to a result of decoding the PSI/SI.

6. The method as claimed in claim 1, wherein the digital video device is a set-top box.

7. The method as claimed in claim 1, wherein the digital video device is a digital television.
